(19) United States
(12) Patent Application Publication
(10) Pub. No.: US 2017/0139689 A1
(43) Pub. Date: May 18, 2017

(54) CACHING METHOD TYPES CREATED FROM METHOD DESCRIPTOR STRINGS ON A PER CLASS LOADER BASIS

(71) Applicant: International Business Machines Corporation, Armonk, NY (US)

(72) Inventors: Daniel J. Heidinga, Ottawa (CA); Bjøm Vàrdal, Richmond (CA)

(21) Appl. No.: 14/939,459

(22) Filed: Nov. 12, 2015

(51) Int. Cl. G06F 9/45; G06F 12/08

(52) U.S. Cl. CPC G06F 8/41; G06F 12/0802; G06F 2212/604

(57) ABSTRACT

A method for caching a MethodType object. The method may include identifying, by a processor, a plurality of classes associated with a method descriptor string. The method may also include determining the identified plurality of classes are loaded into a language runtime environment associated with an object oriented programming language. The method may further include creating the MethodType object using the identified plurality of classes. The method may also include storing the created MethodType object in a cache. The method may further include transmitting the stored MethodType object to the language runtime environment.

### STATEMENT REGARDING PRIOR DISCLOSURES BY THE INVENTOR OR A JOINT

INVENTOR

Aspects of the present invention have been disclosed by another, who obtained the subject matter disclosed directly from the inventors, in the product IBM SDK, Java Technology Edition, Version 8: Beta Program, made available to the public on Dec. 9, 2014. The following disclosure is submitted under 35 U.S.C. §102(b)(1)(A).

### BACKGROUND

The present invention relates generally to the field of computing, and more particularly to virtual machines.

A process virtual machine is a program execution environment that interprets binary code in order to perform a program's instructions. The bytecode may be converted into machine language, such as actions or operating system calls, so that the machine language can be executed on a processor regardless of the installed operating system. The Java virtual machine platform allows the addition of specifications and technologies through the submission and review of Java Specification Requests (JSRs) by Java community members.

### SUMMARY

According to one embodiment, a method for caching a MethodType object. The method may include identifying, by a processor, a plurality of classes associated with a method descriptor string. The method may also include determining the identified plurality of classes are loaded into a language runtime environment associated with an object oriented programming language. The method may further include creating the MethodType object using the identified plurality of classes. The method may also include storing the created MethodType object in a cache. The method may further include transmitting the stored MethodType object to the language runtime environment.

According to another embodiment, a computer system for caching a MethodType object. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The computer system may include identifying a plurality of classes associated with a method descriptor string. The computer system may also include determining the identified plurality of classes are loaded into a language runtime environment associated with an object oriented programming language. The computer system may further include creating the MethodType object using the identified plurality of classes. The computer system may also include storing the created MethodType object in a cache. The computer system may further include transmitting the stored MethodType object to the language runtime environment.

According to yet another embodiment, a computer program product for caching a MethodType object. The computer program product may include one or more computer-readable storage devices and program instructions stored on at least one of the one or more tangible storage devices, the program instructions executable by a processor. The computer program product may include program instructions to identify a plurality of classes associated with a method descriptor string. The computer program product may also include program instructions to determine the identified plurality of classes are loaded into a language runtime environment associated with an object oriented programming language. The computer program product may further include program instructions to create the MethodType object using the identified plurality of classes. The computer program product may also include program instructions to store the created MethodType object in a cache. The computer program product may further include program instructions to transmit the stored MethodType object to the language runtime environment.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description.

FIG. 1 is an exemplary networked computer environment, in accordance with one embodiment of the present invention.

FIG. 2 illustrates a flowchart of the operational steps carried out by a program to process method descriptor strings, in accordance with one embodiment of the present invention.

FIG. 3 is a block diagram of internal and external components of computers and servers depicted in FIG. 1 according to at least one embodiment.

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention are related to the field of computing, and more particularly to virtual machines. The following described exemplary embodiments provide a system, method, and program product to, among other things, create a cache of MethodTypes for method descriptor strings on a class loader basis. Therefore, the present embodiment has the capacity to improve the technical field of virtual machines by increasing system performance and avoiding repeated parsing and class loading of the method descriptor string. Furthermore, memory usage may be reduced since the transitory objects implemented while parsing and creating the MethodType objects may be avoided.

As previously described, a process virtual machine is a program execution environment that interprets binary code in order to perform a program's instructions. The bytecode may be converted into machine language, such as actions or operating system calls, so that the machine language can be executed on a processor regardless of the installed operating system. The virtual machine may be implemented to execute an object oriented programming language, such as Java, Ruby, and Python. The Java platform, for example, allows for updates that add specifications and technologies to the platform by the submission and review of Java Specification Requests (JSRs) by Java community members through the Java Community Process (JCP). The JCP is a mechanism that allows entities, such as individuals or groups, to develop specifications or technologies to enhance the Java environment. JSRs may be proposed by submission through the JCP. Once submitted, JSRs may be assigned a number to help reference specific enhancements made by a specific JSR. For example, the fourteenth JSR, JSR 14, added generic types to the Java programming language.

One notable JSR added through the Java Community Process (JCP) is JSR 292. JSR 292, titled “Supporting Dynamically Typed Language on the Java Platform,” aims to extend the Java virtual machine to support dynamic programming languages, such as Ruby or Python. To achieve this goal, JSR 292 added a dynamic call site (i.e. invokedynamic) instruction at the Java virtual machine level to allow implementation of dynamic method linking and invocation. JSR 292 also included the creation of a MethodType class object. The MethodType class object is described as “a method type [representing] the arguments and return type accepted and returned by a method handle, or the arguments and return type passed and expected by a method handle caller.” Essentially, the MethodType class object may be an aggregate of live classes representing a method signature.

The MethodType class object introduces an application programming interface (API) titled static MethodType fromMethodDescriptorString(String descriptor, ClassLoader loader). The API description states that the API “finds or creates an instance of a method type, given the spelling of its bytecode descriptor. Convenience method for MethodType. Any class or interface name embedded in the descriptor string will be resolved by calling ClassLoader.loadClass(java.lang.String) on the given loader (or if it is null, on the system class loader).”

With the introduction of lambda expressions in the Java 8 platform, the usage of the API for the MethodType class object by standard Java programs, including the core class library, has greatly increased due to the means by which the lambda expressions are expressed in the bytecode. Each Java lambda expression results in an invokedynamic call that will call the lambda metafactory to create the JSR 292 CallSite object that is used to return the lambda. The metafactory API may result in three calls to the
MethodTypefromMethodDescriptorString(String,ClassLoader) method.

Since lambda expressions may use a limited number of functional interfaces, which will invoke a soft restriction on the number of unique lambda signatures, the same method descriptor strings may be used multiple times. A function interface may refer to a method of storing lambda expressions in an object and ensuring type-safety. Any interface that only declares one method may be considered a functional interface. Each time a method descriptor string is processed, the Java virtual machine parses the string and performs an individual lookup of each class mentioned within the string. The Java virtual machine must then find or create the matching interned MethodType objects resulting in redundant processing.

Therefore a MethodType cache may be beneficial to use in a virtual machine. However, cross-class loader dependencies may negatively impact garbage collection. A difficulty may arise when there is a reference from the MethodType class to many other classes that are not loaded by the same class loader as MethodType. For example, when class loader 1 (CL1) loads the MethodType class, class loader 2 (CL2) loads the SomeClass class, and class loader 3 (CL3) loads the OtherClass class, SomeClass may create a MethodType that refers to OtherClass and the MethodType is stored in the MethodType cache on the MethodType class. Due to the arrangement of class loaders, garbage collection of CL2 may not be possible because MethodType, which was loaded by CL1, has a mapping that contains a MethodType referring to OtherClass. Therefore, a new dependency is introduced between class loaders that may prevent proper class unloading. As such, it may be advantageous, among other things, to create a per-class loader cache that maps from the method descriptor string to the MethodType object to avoid repeated parsing and class loading of the method descriptor string, since mapping of method descriptor strings to MethodType objects is specific to the class loader, such as Java Classloader, being used to resolve the classes. Furthermore, designating a class loader specific cache may remove the dependencies by ensuring the lifespan of the cache is the same as the lifespan of the classes referred to by the cache.

According to one embodiment, a cache may be added to each class loader that maps from the method descriptor string to the resulting MethodType. The MethodTypefromMethodDescriptorString(String,ClassLoader) call may first check the map associated with the class loader to determine if the class loader has already resolved a MethodType matching the string. A class loader may be a program capable of loading Java classes into a Java virtual machine. If a MethodType matching the string has already been resolved, the MethodTypefromMethodDescriptorString(String,ClassLoader) call may immediately return the MethodType and avoid the parsing and processing needed to resolve the class object for each entity in the method descriptor string. Such a method may also avoid unnecessary allocations of MethodType objects. Furthermore, if a String-MethodType pair is not already present in the map, the MethodType may be created and the per-class loader map may be updated for the class loader.

For example, with regards to the previous example involving CL1, CL2, and CL3, if the MethodType cache is implemented in the ClassLoader class, the MethodType cache, which was previously in CL1, may now be within CL2 (i.e. the class loader for OtherClass). When a garbage collection is attempted for CL2, no references to CL2 from CL1 may exist and a garbage collection may be possible. Therefore, this method may ensure that the MethodType cache has the same lifespan as the classes referred to by the MethodType objects in the cache.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to create a cache of MethodTypes for method descriptor strings on a class loader basis. According to at least one implementation, a cache of MethodTypes for each class loader may be created from method descriptor strings. Therefore, when subsequent method descriptor strings are executed, the cache may be analyzed to determine if the MethodType is included so that redundant parsing and processing of a MethodType that is encountered in typical solutions may be avoided.

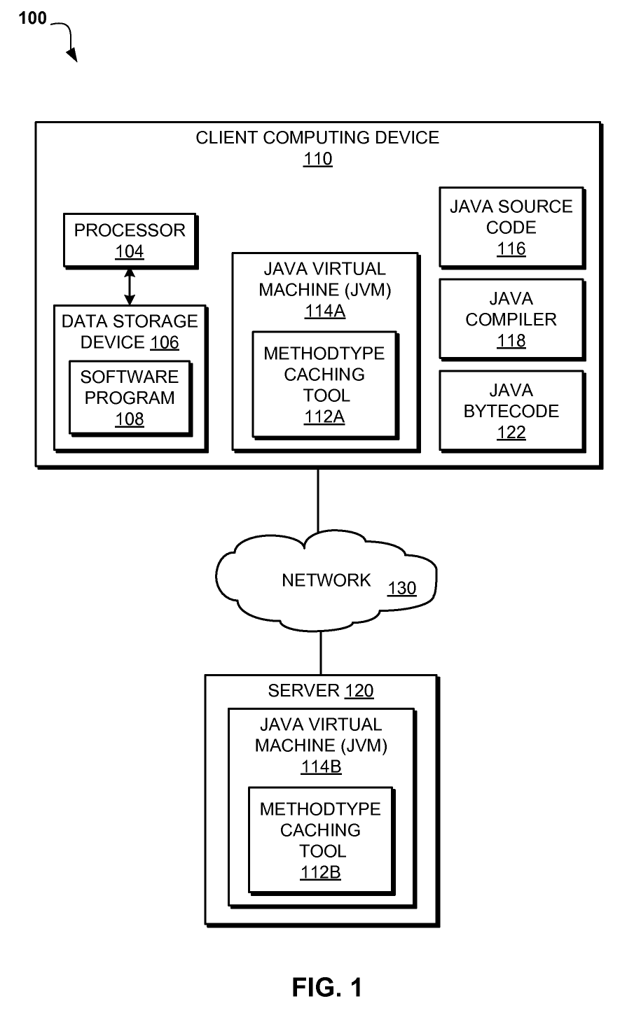

Referring to FIG. 1, an exemplary networked computer environment 100 is depicted, in accordance with one embodiment. The networked computer environment 100 may include a client computing device 110 and a server 120 interconnected via a communication network 130. According to at least one implementation, the networked computer environment 100 may include a plurality of client computing devices 110 and servers 120, only one of each being shown for illustrative brevity.

The communication network 130 may include various types of communication networks, such as a wide area network (WAN), local area network (LAN), a telecommunication network, a wireless network, a public switched network and/or a satellite network. The communications network 130 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

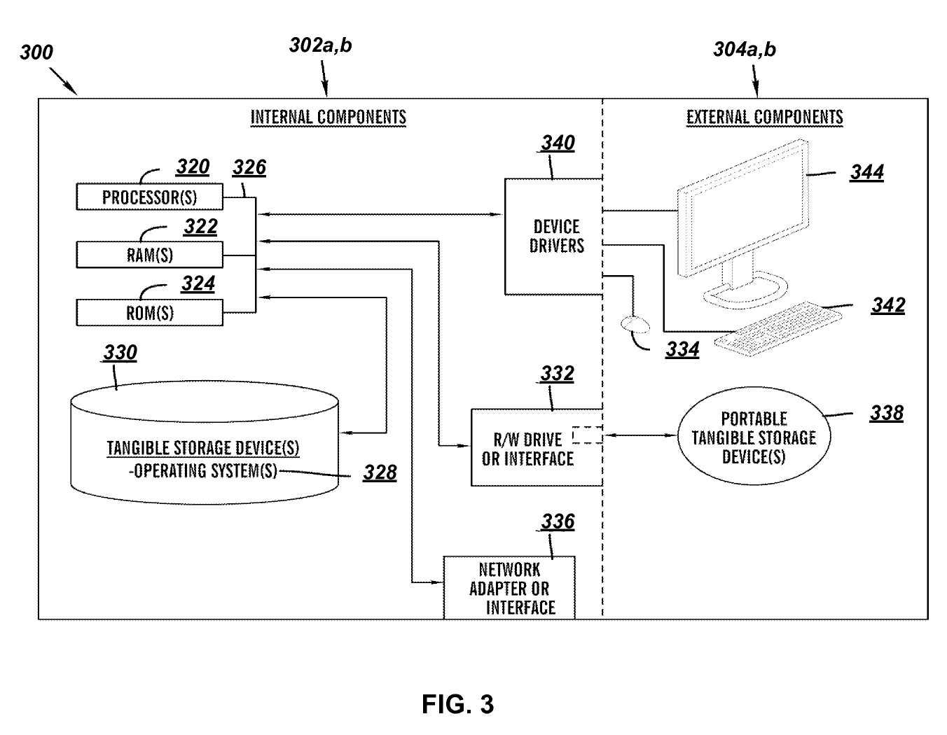

The client computing device 110 may include a processor 104 and a data storage device 106 that is enabled to run a software program 108 and may be capable of hosting a Java Virtual Machine (JVM) 114A and a MethodType Caching Tool 112A and communicating with the server 120 via the network 130, in accordance with one embodiment of the invention. The client computing device 110 may be, for example, a mobile device, a telephone, a personal digital assistant, a netbook, a laptop computer, a tablet computer, a desktop computer, or any type of computing device capable of running a program and accessing a network. The client computing device 110 may include Java source code 116 capable of being compiled by a Java compiler 118 into Java bytecode 122. Compilation need not occur in real-time and need not occur within the same environment as the JVM 114A. As will be discussed with reference to FIG. 3, the client computing device 110 may include internal components 302a and external components 304a, respectively.

The server computer 120 may be a laptop computer, netbook computer, personal computer (PC), a desktop computer, or any programmable electronic device capable of hosting a Java Virtual Machine 114B and a MethodType Caching Tool 112B and communicating with the client computing device 110 via the network 130, in accordance with embodiments of the invention. As will be discussed with reference to FIG. 3, the server computer 120 may include internal components 302b and external components 304b, respectively. The server 120 may also operate in a cloud computing service model, such as Software as a Service (SaaS), Platform as a Service (PaaS), or Infrastructure as a Service (IaaS). The server 120 may also be located in a cloud computing deployment model, such as a private cloud, community cloud, public cloud, or hybrid cloud.

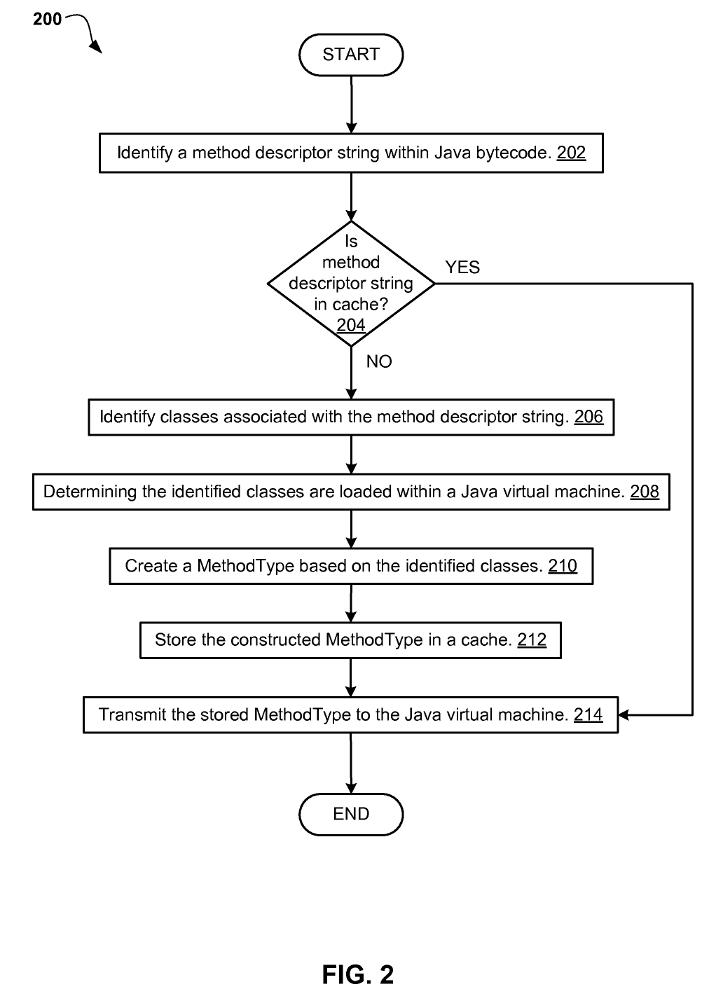

According to the present embodiment, the MethodType Caching Tool 112A, 112B may be a program capable of creating a per-class loader cache that maps from method descriptor strings to a MethodType object. The MethodType Caching Tool 112A, 112B is explained in further detail below with respect to FIG. 2.

Referring now to FIG. 2, a flowchart 200 of the operational steps carried out by a program to process method descriptor strings is depicted, in accordance with one embodiment of the present invention. At 202, the MethodType Caching Tool 112A, 112B (FIG. 1) identifies a method descriptor string from the Java bytecode 122 (FIG. 1). The method descriptor string may be an existing text string of Java bytecode 122 (FIG. 1). Once the Java source code 116 (FIG. 1) is compiled by the Java compiler 118 (FIG. 1) into Java bytecode 122 (FIG. 1), the Java bytecode 122 (FIG. 1) may be analyzed by MethodType Caching Tool 112A, 112B (FIG. 1). When the Java source code 116 (FIG. 1) was compiled by Java compiler 118 (FIG. 1) into Java bytecode 122 (FIG. 1), a class file may be created that contains a Java class. When the Java bytecode 122 (FIG. 1) is run in the class file, a constant pool may utilized to identify any text strings or other constants used within the Java bytecode 122 (FIG. 1). The constant pool may be a library that includes any text strings or various constants recognized by the JVM 114A, 114B (FIG. 1). The method descriptor string may be identified by the MethodType Caching Tool 112A, 112B (FIG. 1) through analysis of the constant library.

Next at 204, the MethodType Caching Tool 112A, 112B (FIG. 1) determines whether the identified method descriptor string is stored within cache memory. According to one implementation, the method may continue along operational flowchart 200, if the identified method descriptor string is not stored within cache memory. If the MethodType Caching Tool 112A, 112B (FIG. 1) determines the identified method descriptor string is stored within cache memory (step 204, “YES” branch), the MethodType Caching Tool 112A, 112B (FIG. 1) may continue to step 214 to return the corresponding MethodType to the JVM 114A, 114B (FIG. 1).

If the MethodType Caching Tool 112A, 112B (FIG. 1) determines the identified method descriptor string is not stored within cache memory (step 204, “NO” branch), the MethodType Caching Tool 112A, 112B (FIG. 1) may continue along the operation flowchart 200 to step 206 to parse the identified method descriptor string.

Then at 206, the MethodType Caching Tool 112A, 112B (FIG. 1) identifies classes associated with the identified method descriptor string. The MethodType Caching Tool 112A, 112B (FIG. 1) may identify the classes associated with the method descriptor string by parsing through the identified method descriptor string. Since the identified method descriptor string describes each argument that may pass to a method, the MethodType Caching Tool 112A, 112B (FIG. 1) may be capable of reading and extracting information about the method types referred to within the identified method descriptor string. Therefore, the MethodType Caching Tool 112A, 112B (FIG. 1) may parse through the identified method descriptor string to determine which classes need to be identified and loaded to JVM 114A, 114B (FIG. 1). For example, if the MethodType Caching Tool 112A, 112B (FIG. 1) is passing a string, an object, and a second string, the MethodType Caching Tool 112A, 112B (FIG. 1) may parse that each item. The MethodType Caching Tool 112A, 112B (FIG. 1) may need to identify the java.lang.Class or the string, the class object, and the second string to create a descriptor.

Next at 208, the MethodType Caching Tool 112A, 112B (FIG. 1) determines each identified class is loaded to the JVM 114A, 114B (FIG. 1). Once the MethodType Caching Tool 112A, 112B (FIG. 1) parses through the identified method descriptor string to determine which classes need to be loaded, the MethodType Caching Tool 112A, 112B (FIG. 1) may ensure that the appropriate classes are loaded to the JVM 114A, 114B (FIG. 1). For example, if the MethodType Caching Tool 112A, 112B (FIG. 1) determines a string relates to a java.lang.Object, then the MethodType Caching Tool 112A, 112B (FIG. 1) may ensure that the class or classes associated with the Java length object are loaded. Since the MethodType Caching Tool 112A, 112B (FIG. 1) may parse through multiple strings, the MethodType Caching Tool 112A, 112B (FIG. 1) may attempt to load the same class twice. If the MethodType Caching Tool 112A, 112B (FIG. 1) determines that a class has already been loaded, the MethodType Caching Tool 112A, 112B (FIG. 1) may not load a class that has already been loaded in order to prevent redundancy and conserve resources. Furthermore, the MethodType Caching Tool 112A, 112B (FIG. 1) may determine which classes need to be loaded to JVM 114A, 114B (FIG. 1) by utilizing a class loader. As previously described, a class loader may be a program capable of loading classes into a Java virtual machine. The class may be located within a class file within a repository, such as a file system. Typical methods of obtaining class files including compiling the Java source code 116 (FIG. 1) using the java compiler 118 (FIG. 1).

Then at 210, the MethodType Caching Tool 112A, 112B (FIG. 1) constructs the corresponding MethodType. Once the classes corresponding to the identified method descriptor string have been uploaded to JVM 114A, 114B (FIG. 1), the MethodType Caching Tool 112A, 112B (FIG. 1) may construct the MethodType using the uploaded classes. The constructed MethodType may be an aggregate of live classes identified by the MethodType Caching Tool 112A, 112B (FIG. 1). Furthermore, the MethodType Caching Tool 112A, 112B (FIG. 1) may intern MethodTypes. Interning a MethodType means the MethodType Caching Tool 112A, 112B (FIG. 1) may utilize another MethodType object that utilizes the same arguments without creating a duplicate MethodType to be stored in the cache. For example, if a MethodType is created for identified method descriptor string A, a separate MethodType may not be created for identified method descriptor string B, if identified method descriptor string B has the same arguments and return types as identified method descriptor string A. Therefore, the MethodType Caching Tool 112A, 112B (FIG. 1) may avoid creating duplicate MethodType objects.

Next at 212, the MethodType Caching Tool 112A, 112B (FIG. 1) adds the constructed MethodType to the cache memory. Once the MethodType Caching Tool 112A, 112B (FIG. 1) creates the corresponding MethodType, the MethodType Caching Tool 112A, 112B (FIG. 1) may store the constructed MethodType in the cache memory. In one embodiment, the cache may be located in the class loader object. Storing the cache in the class loader object may avoid dependencies across class loaders, and may therefore be more memory efficient than typical cache locations. Such MethodType objects may remain as long as the class exists, which may be same lifespan as the class loader. Additionally, the MethodDescriptor string object may be used as a key, which may already be stored in the MethodType object. Therefore, additional object allocations may be avoided, which may minimize the space cost of the cache.

Then at 214, the MethodType Caching Tool 112A, 112B (FIG. 1) returns the corresponding added MethodType to the JVM 114A, 114B (FIG. 1). Once created and stored in cache memory, the added MethodType may be returned to the JVM 114A, 114B (FIG. 1) so that the added MethodType may be processed by the JVM 114A, 114B (FIG. 1).

It may be appreciated that FIG. 2 provides only an illustration of one implementation and does not imply any limitations with regard to how different embodiments may be implemented. Many modifications to the depicted environments may be made based on design and implementation requirements. For example, despite references being made to the JVM 114A, 114B (FIG. 1), the Java source code 116 (FIG. 1), the Java compiler 118 (FIG. 1), and the Java bytecode 122 (FIG. 1), a virtual machine, source code, compiler, and bytecode associated with any object oriented programming language may be utilized.

FIG. 3 is a block diagram 300 of internal and external components of client computing device 110 and server 120 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 302, 304 is representative of any electronic device capable of executing machine-readable program instructions. Data processing system 302, 304 may be representative of a smart phone, a computer system, PDA, or other electronic devices. Examples of computing systems, environments, and/or configurations that may represented by data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Client computing device 110 (FIG. 1) and server 120 (FIG. 1) may include respective sets of internal components 302 a,b and external components 304 a,b illustrated in FIG. 3. Each of the sets of internal components 302 include one or more processors 320, one or more computer-readable RAMs 322 and one or more computer-readable ROMs 324 on one or more buses 326, and one or more operating systems 328 and one or more computer-readable tangible storage devices 330. The one or more operating systems 328, MethodType Caching Program 112A (FIG. 1) in client computer 110 (FIG. 1) and MethodType Caching Program 112B (FIG. 1) in server 120 (FIG. 1) are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as MethodType Caching Program 112A, 112B (FIG. 1), can be stored on one or more of the respective portable computer-readable tangible storage devices 338, read via the respective R/W drive or interface 332 and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. MethodType Caching Program 112A (FIG. 1) in client computer 110 (FIG. 1) and MethodType Caching Program 112B (FIG. 1) in server 120 (FIG. 1) can be downloaded to client computer 110 (FIG. 1) and server 120 (FIG. 1) from an external computer via a network (for example, the Internet, a local area network or other, wide area network) and respective network adapters or interfaces 336. From the network adapters or interfaces 336, MethodType Caching Program 112A (FIG. 1) in client computer 110 (FIG. 1) and MethodType Caching Program 112B (FIG. 1) in server 120 (FIG. 1) are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332 and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

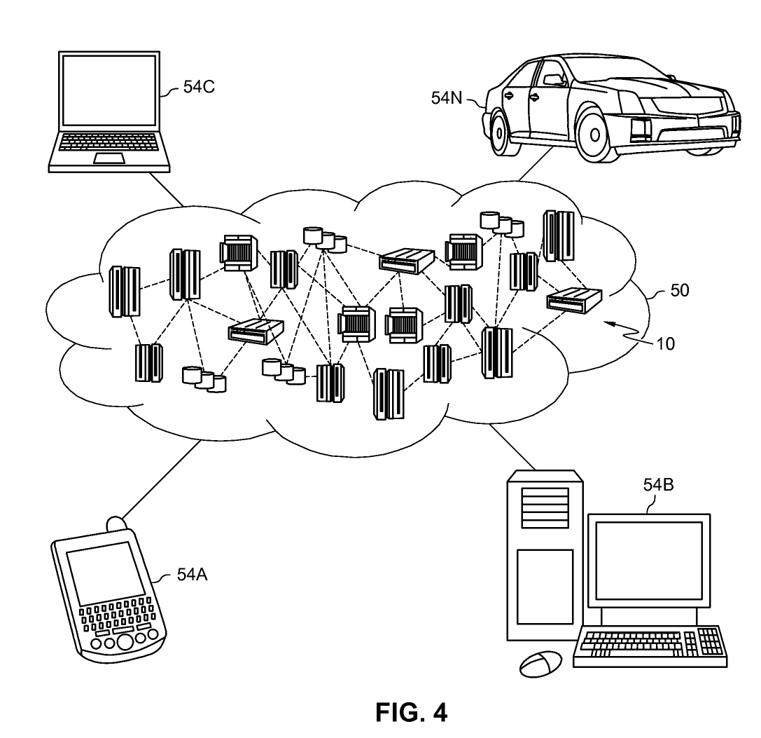

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

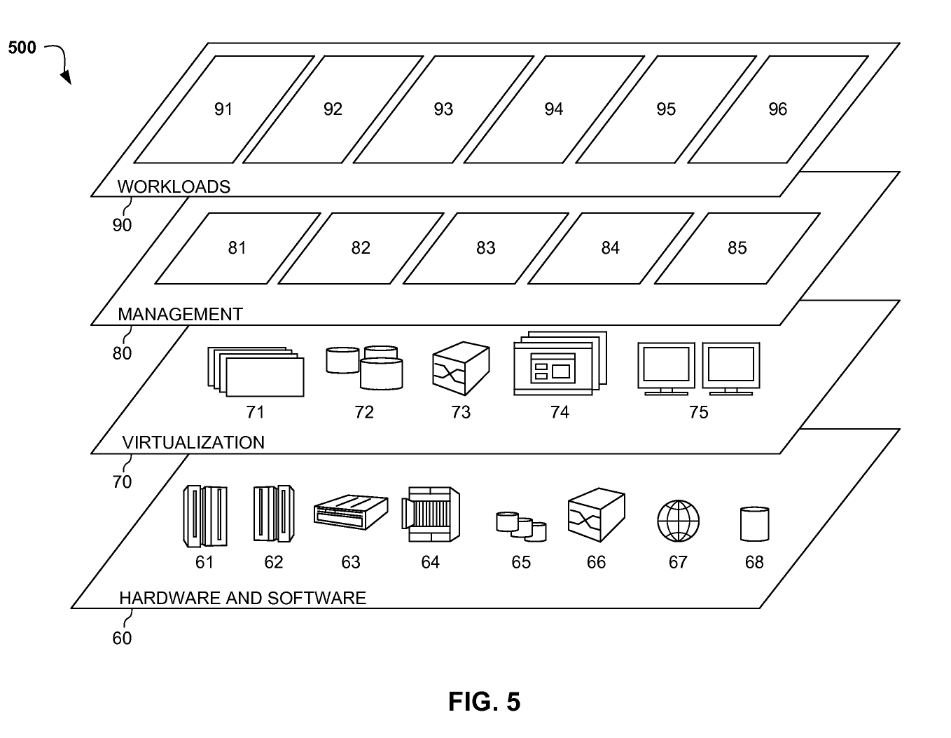

Referring now to FIG. 5, a set of functional abstraction layers 500 provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and caching MethodTypes 96. Caching MethodTypes 96 may refer to adding a cache to a class loader that maps from method descriptor strings to the resulting MethodType.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for caching a MethodType object, the method comprising:
identifying, by a processor, a plurality of classes associated with a method descriptor string;
determining the identified plurality of classes are loaded into a language runtime environment associated with an object oriented programming language;
creating the MethodType object using the identified plurality of classes;
storing the created MethodType object in a cache; and
transmitting the stored MethodType object to the language runtime environment.

2. The method of claim 1, further comprising:
identifying the method descriptor string within a plurality of bytecode; and
determining the identified method descriptor string is not stored within a cache.

3. The method of claim 1, wherein determining the identified plurality of classes includes parsing the method descriptor string for at least one argument and a plurality of information corresponding to at least one method type.

4. The method of claim 1, further comprising:
determining at least one class within the identified plurality of classes is not loaded into the language runtime environment; and
transmitting the at least one class to the language runtime environment.

5. The method of claim 1, wherein the created MethodType object is stored in the cache on a per-class loader basis.

6. The method of claim 1, wherein the MethodType object is created by aggregating the identified plurality of classes.

7. The method of claim 2, wherein the method descriptor string within the bytecode is identified by executing the bytecode with a class file.

8. A computer system for caching a MethodType object, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a plurality of classes associated with a method descriptor string;
determining the identified plurality of classes are loaded into a language runtime environment associated with an object oriented programming language;
creating the MethodType object using the identified plurality of classes;
storing the created MethodType object in a cache; and
transmitting the stored MethodType object to the language runtime environment.

9. The computer system of claim 8, further comprising:
identifying the method descriptor string within a plurality of bytecode; and
determining the identified method descriptor string is not stored within a cache.

10. The computer system of claim 8, wherein determining the identified plurality of classes includes parsing the method descriptor string for at least one argument and a plurality of information corresponding to at least one method type.

11. The computer system of claim 8, further comprising:
determining at least one class within the identified plurality of classes is not loaded into the language runtime environment; and
transmitting the at least one class to the language runtime environment.

12. The computer system of claim 8, wherein the created MethodType object is stored in the cache on a per-class loader basis.

13. The computer system of claim 8, wherein the MethodType object is created by aggregating the identified plurality of classes.

14. The computer system of claim 9, wherein the method descriptor string within the bytecode is identified by executing the bytecode with a class file.

15. A computer program product for caching a MethodType object, the computer program product comprising:
one or more computer-readable tangible storage medium and program instructions stored on at least one of the one or more tangible storage medium, the program instructions executable by a processor, the program instructions comprising:
program instructions to identify a plurality of classes associated with a method descriptor string;
program instructions to determine the identified plurality of classes are loaded into a language runtime environment associated with an object oriented programming language;
program instructions to create the MethodType object using the identified plurality of classes;
program instructions to store the created MethodType object in a cache; and
program instructions to transmit the stored MethodType object to the language runtime environment.

16. The computer program product of claim 15, further comprising:
program instructions to identify the method descriptor string within a plurality of bytecode; and
program instructions to determine the identified method descriptor string is not stored within a cache.

17. The computer program product of claim 15, wherein determining the identified plurality of classes includes parsing the method descriptor string for at least one argument and a plurality of information corresponding to at least one method type.

18. The computer program product of claim 15, further comprising:
program instructions to determine at least one class within the identified plurality of classes is not loaded into the language runtime environment; and
program instructions to transmit the at least one class to the language runtime environment.

19. The computer program product of claim 15, wherein the created MethodType object is stored in the cache on a per-class loader basis.

20. The computer program product of claim 15, wherein the MethodType object is created by aggregating the identified plurality of classes.
